(19) United States
(12) Patent Application Publication
(10) Pub. No.: US 2010/0047453 A1
(43) Pub. Date: Feb. 25, 2010

(54) INK COMPOSITION FOR INK-JET PRINTING AND PRINTING METHOD

(75) Inventors: Akihito Sao, Matsumoto-shi (JP); Yasunari Ikeda, Shiojiri-shi (JP)

Correspondence Address: LADAS & PARRY, 26 West 61st Street, New York, NY, 10023, US

(73) Assignee: SEIKO EPSON CORPORATION

(21) Appl. No.: 12/511,540

(22) Filed: Jul. 29, 2009

(30) Foreign Application Priority Data
Aug. 22, 2008 (JP) 2008-214573

(51) Int. Cl. C09D 11/02; B05D 5/00

(52) U.S. Cl. 427/256; 106/31.27

(57) ABSTRACT

An ink composition for ink-jet printing contains a water-soluble dye having an anthraquinone skeleton and a water solubility of 50 g/L or less at 30° C. and at least one polyoxyethylene alkyl ether having an HLB of 11.4 to 18.8 and the following formula:

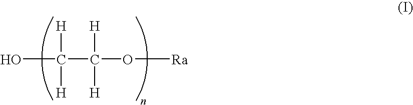

wherein n is four to 100 and Ra is a saturated alkyl group with eight to 24 carbon atoms.

### BACKGROUND

1. Technical Field

The present invention relates to an ink composition for ink-jet printing and a printing method using the ink composition.

2. Related Art

The following processes have been conventionally used to print patterns such as images and characters on pieces of fabric: screen-printing methods, roller-printing methods, rotary screen-printing methods, and transfer printing methods. The conventional methods require complicated operations for preparing traces and/or printing plates for each pattern and therefore are unsuitable for cost reduction, particularly for high-mix low-volume production. In order to solve these disadvantages, the following method has been developed and put into practical use: an ink-jet printing method in which an image sample is read with an image input device such as a scanner, processed with a computer, and then printed on a piece of fabric by an ink-jet recording process in accordance with obtained image information. The ink-jet recording process is as follows: ink droplets are ejected from an ink head toward a recording medium such as a piece of paper or fabric so as to be applied to the recording medium. The ink-jet recording process has already been widely used for printing on paper is being attempted to be used for printing on fabric.

For example, Japanese Unexamined Patent Application Publication No. 7-3666 discloses an ink-jet printing method and an ink set including a combination of dyes with perceived chromaticity indexes a and b specified in a hue range (CIE 1976 (L*a*b*) space) on a cloth.

Japanese Unexamined Patent Application Publication No. 8-302266 discloses an aqueous ink, having good lubricity and smooth writing touch, for ball-point pens. The aqueous ink contains a dye, water, and a polyoxyethylene alkyl ether having the formula RO(CH₂CH₂O)ₙH, wherein R is an alkyl group with 16 to 18 carbon atoms and n is a number greater than or equal to 3.

Japanese Unexamined Patent Application Publication No. 8-209048 discloses an ink-jet water-dispersible ink which is fixable to plain paper and fabric and which has good color developability and fastness. The ink-jet water-dispersible ink contains water, a water-soluble organic solvent, a dispersive dye or pigment, an alkali-soluble, water-soluble polymer with a carboxylic acid number, and/or a surfactant. The surfactant is a polyoxyethylene alkyl ether or polyoxyethylene alkylphenyl ether which contains ethylene oxide units terminated with an anionic dissociable group selected from a phosphoric group and a carboxylic group and which has a hydrophile-lipophile balance (HLB) of ten or more.

### SUMMARY

The inventors have found that a record having good water solubility, stability, printing properties, color, sharpness, light resistance, and fastness can be prepared by an ink-jet printing method in such a manner that a water-soluble dye with a specific anthraquinone skeleton is used in combination with a specific polyoxyethylene alkyl ether. The present invention is based the finding.

An advantage of some aspects of the present invention is to provide an ink composition, having good water solubility, stability, printing properties, color, sharpness, light resistance, and fastness, for ink-jet printing.

An ink composition, according to the present invention, for ink-jet printing contains a water-soluble dye having an anthraquinone skeleton and a water solubility of 50 g/L or less at 30° C. and at least one polyoxyethylene alkyl ether having an HLB of 11.4 to 18.8 and the following formula:

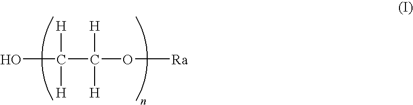

wherein n is four to 100 and Ra is a saturated alkyl group with eight to 24 carbon atoms.

An ink-jet printing method includes using the ink composition.

According to the present invention, an ink composition for ink-jet printing can be provided. The ink composition is capable of achieving good water solubility, stability, printing properties, color, sharpness, light resistance, and fastness.

### DESCRIPTION OF EXEMPLARY EMBODIMENTS

An ink composition, according to an embodiment of the present invention, for ink-jet printing contains a water-soluble dye which has an anthraquinone skeleton and a water solubility of 50 g/L or less at 30° C. and also contains at least one polyoxyethylene alkyl ether which has an HLB of 11.4 to 18.8 and Formula (I) described above.

The term “HLB” as used herein is defined as a value determined by the following equation:

HLB=I/O×10

wherein I is an inorganic value and O is an organic value specified in an organic conceptual diagram.

Inorganic and organic values are specified in Koda, Y, Yuki Gainenzu—Kiso to Oyo and Fujita, A et al., Keitoteki Yuki Teisei Bunseki (Kongobutuhen).

The water-soluble dye has the anthraquinone skeleton and a water solubility of 50 g/L or less at 30° C. as described above. Preferred examples of the water-soluble dye include C. I. Acid Blues 258, 280, and 290. The water-soluble dye is preferably C. I. Acid Blue 290.

The content of the water-soluble dye in the ink composition may be determined such that good water solubility, stability, printing properties, color, sharpness, light resistance, and fastness can be achieved. The content of the water-soluble dye therein is preferably, for example, 10% by weight or less.

The polyoxyethylene alkyl ether has an HLB of 11.4 to 18.8 and Formula (I) as described above. The polyoxyethylene alkyl ether contains a saturated alkyl group represented by Ra in Formula (I). The saturated alkyl group may be linear or branched and is preferably linear.

It is preferred that the polyoxyethylene alkyl ether have an HLB of 12.1 to 17.9, the saturated alkyl group have eight to 24 carbon atoms, and n in Formula (I) be four to 100. It is more preferred that the polyoxyethylene alkyl ether have an HLB of 12.1 to 16.4, the saturated alkyl group have eight to 24 carbon atoms, and n in Formula (I) be four to 60. The following ethers may be used in combination: a first polyoxyethylene alkyl ether which has Formula (I), which contains a saturated alkyl group with eight to ten carbon atoms, and in which n in Formula (I) is four to 20 and a second polyoxyethylene alkyl ether which has Formula (I), which contains a saturated alkyl group with 12 to 24 carbon atoms, and in which n in Formula (I) is ten to 60. The ratio of the content of the first polyoxyethylene alkyl ether to the content of the second in the ink composition is preferably 1:5 to 5:1 and more preferably 1:2 to 2:1.

The content of the polyoxyethylene alkyl ether in the ink composition may be determined such that good water solubility, stability, printing properties, color, sharpness, light resistance, and fastness can be achieved. The content of the polyoxyethylene alkyl ether therein is preferably 6% to 15% by weight when the polyoxyethylene alkyl ether has an HLB of 11.4 to 18.8, the saturated alkyl group of the polyoxyethylene alkyl ether has eight to 24 carbon atoms, and n in Formula (I) is four to 100. The content of the polyoxyethylene alkyl ether therein is preferably 3% to 15% by weight when the polyoxyethylene alkyl ether has an HLB of 12.1 to 17.9, the saturated alkyl group of the polyoxyethylene alkyl ether has eight to 24 carbon atoms, and n in Formula (I) is four to 100 or when the polyoxyethylene alkyl ether has an HLB of 12.1 to 16.4, the saturated alkyl group of the polyoxyethylene alkyl ether has eight to 24 carbon atoms, and n in Formula (I) is four to 60.

The sum of the content of the first polyoxyethylene alkyl ether and the content of the second polyoxyethylene alkyl ether in the ink composition is preferably 4% by weight or more.

The sum of the content of the first polyoxyethylene alkyl ether and the content of the second polyoxyethylene alkyl ether in the ink composition is preferably 2.0 times or more the content of the water-soluble dye in the polyoxyethylene alkyl ether.

The ratio of the content of the polyoxyethylene alkyl ether in the ink composition to the content of the water-soluble dye in the polyoxyethylene alkyl ether may be determined such that good water solubility, stability, printing properties, color, sharpness, light resistance, and fastness can be achieved. The ratio of the content of the polyoxyethylene alkyl ether in the ink composition to the content of the water-soluble dye in the polyoxyethylene alkyl ether is preferably 1.0:3.0 to 1.0:7.5 when the polyoxyethylene alkyl ether has an HLB of 11.4 to 18.8, the saturated alkyl group of the polyoxyethylene alkyl ether has eight to 24 carbon atoms, and n in Formula (I) is four to 100. The ratio of the content of the polyoxyethylene alkyl ether in the ink composition to the content of the water-soluble dye in the polyoxyethylene alkyl ether is preferably 1.0:1.5 to 1.0:7.5 when the polyoxyethylene alkyl ether has an HLB of 12.1 to 17.9, the saturated alkyl group of the polyoxyethylene alkyl ether has eight to 24 carbon atoms, and n in Formula (I) is four to 100 or when the polyoxyethylene alkyl ether has an HLB of 12.1 to 16.4, the saturated alkyl group of the polyoxyethylene alkyl ether has eight to 24 carbon atoms, and n in Formula (I) is four to 60.

In order to stably eject the ink composition from nozzles of recording heads of ink jet printers, the ink composition preferably further contains a humectant. The humectant may be any compound, contained in common ink compositions for ink-jet printing, absorbing water. Examples of the humectant include polyols such as glycerin, ethylene glycol, diethylene glycol, triethylene glycol, tetraethylene glycol, polyethylene glycol, propylene glycol, dipropylene glycol, polypropylene glycol, 1,3-propanediol, 1,4-butanediol, 1,2-hexanediol, 1,5-pentanediol, 1,6-hexanediol, 1,2,6-hexanetriol, and pentaerythritol; ethers of the polyols; esters of the polyols; lactams such as 2-pyrrolidone, N-methyl-2-pyrrolidone, and ε-caprolactam; ureas such as urea, thiourea, ethylene urea, and 1,3-dimethylimidazolidinone; and sugars such as maltitol, sorbitol, gluconolactone, and maltose. These compounds may be used alone or in combination. The content of the humectant in the ink composition is preferably 4% to 40% by weight.

In order to allow the ink composition to have high wettability and permeability to fabric, the ink composition preferably further contains a water-soluble organic solvent serving as a penetrant. The water-soluble organic solvent may be any compound used in common ink compositions for ink-jet printing as a penetrant. Examples of the water-soluble organic solvent include lower alcohols such as ethanol and propanol; cellosolves such as ethylene glycol monomethyl ether and ethylene glycol monoethyl ether; carbitols such as diethylene glycol monomethyl ether and diethylene glycol monoethyl ether; and glycol ethers such as ethylene glycol mono-n-butyl ether, diethylene glycol n-butyl ether, and triethylene glycol n-butyl ether. These compounds may be used alone or in combination. The content of the water-soluble organic solvent in the ink composition is preferably 2% to 15% by weight.

The ink composition may further contain a surfactant serving as a humectant in addition to the polyoxyethylene alkyl ether. The surfactant may be any compound used in common ink compositions for ink-jet printing as a penetrant. Examples of the surfactant include fatty acid salts; anionic surfactants such as alkylsulfonates; nonionic surfactants such as polyoxyethylene alkylphenyl ether; acetylene glycol surfactants such as Surfynols™ 61, 82, 104, 440, 465, and 485 available from Air Products and Chemicals, Inc.; cationic surfactants; and amphoteric surfactants. These surfactants may be used alone or in combination. The content of the surfactant in the ink composition is preferably 0.2% to 2% by weight.

The ink composition may further contains water as a balance as required in addition to the water-soluble dye, the humectant, and the water-soluble organic solvent. Examples of the water contained in the ink composition include pure waters such as ion-exchanged water, ultrafiltered water, reverse osmosis-purified water, and distilled water and ultrapure waters. These waters are preferably sterilized by ultraviolet irradiation or with aqueous hydrogen peroxide because mold and bacteria can be prevented from growing in these waters over a long time.

The ink composition may further contain one or more additives, such as fungicides, preservatives, oxidation inhibitors, ultraviolet absorbers, chelating agents, oxygen absorbers, pH adjusters (for example, triethanolamine), and dissolution aids, useful in common ink compositions for ink-jet printing as required.

In view of the balance between the printing quality and reliability of the ink composition, the ink composition preferably has a surface tension of 25 to 40 mN/m and more preferably 28 to 35 mN/m. Furthermore, the ink composition preferably has a viscosity of 1.5 to 10 mPa·s and more preferably 2 to 8 mPa·s at 20° C. The surface tension and viscosity of the ink composition can be adjusted within the above ranges in such a manner that the content of the water-soluble dye, the type of the humectant, and/or the content of the humectant is varied.

A record having good water solubility, stability, printing properties, color, sharpness, light resistance, and fastness can be prepared in such a manner that the ink composition is applied to a piece of fabric, such as woven fabric, knitted fabric, or nonwoven fabric, made of synthetic polyamide fibers by ink-jet printing. The ink composition, as well as common ink compositions for ink-jet printing, is used in such a manner that the ink composition is supplied to an ink-jet printer. The ink-jet printer is not particularly limited and is preferably of a drop-on-demand type. Drop-on-demand type ink-jet printers use a piezoelectric element-recording process in which piezoelectric elements mounted in recording heads are used for recording or a thermal jet recording process in which the heat energy generated by heaters, such as heat-generating resistors, mounted in recording heads is used for recording. Any of these recording processes can be used herein.

In the case where the ink composition is applied to the fabric piece by an ink-jet printing method, the fabric piece is preferably pretreated with a pretreatment agent. The pretreatment of the fabric piece is as follows: the fabric piece is immersed in the pretreatment agent or after the pretreatment agent is applied to the fabric piece by coating, spraying, or the like, the fabric piece is dried.

The pretreatment agent may be an aqueous solution containing 0.0l% to 20% by weight of a sizing agent such as a water-soluble polymer. Examples of the sizing agent include starches such as corn starch and wheat starch; celluloses such as carboxymethylcellulose and hydroxymethylcellulose; polysaccharides such as sodium alginate, gum arabic, locust bean gum, trant gum, guar gum, and tamarind gum; proteins such as gelatin and casein; tannin; natural water-soluble polymers such as lignin; and synthetic water-soluble polymers such as polyvinyl alcohols, polyethylene oxides, acrylic polymers, and maleic anhydride polymers. The pretreatment agent may contain a humectant such as urea or thiourea, a pH adjuster, a reduction inhibitor, a penetrant, a sequestering agent, an anti-foaming agent, and/or an additive as required.

In the case where the ink composition is applied to the fabric piece by the ink-jet printing method, after a character and/or an image is printed on the fabric piece by applying the ink composition to the fabric piece, the water-soluble dye is fixed. Examples of a process for fixing the water-soluble dye include an atmospheric-pressure steaming process, high-pressure steaming process, and thermo-fixing process similar to a dye-fixing process used in a conventional printing method. After the water-soluble dye is fixed, the fabric piece is water-washed and then dried in accordance with common practice. The fabric piece may be subjected to soaping as required such that the unfixed water-soluble dye is washed off with a hot soap solution.

### EXAMPLES

The present invention will be further described in detail with reference to examples. The present invention is not limited to the examples.

### Preparation of Ink Compositions

Each ink composition was prepared so as to have the composition below in such a manner that components were mixed together and the mixture was filtered through a 10-μm membrane filter. Surfactants used to prepare the ink compositions contained polyoxyethylene alkyl ethers which had Formula (I) and which contained saturated alkyl groups represented by Ra in Formula (I). The number of carbon atoms in the saturated alkyl groups, n in Formula (I), and the HLBs of the saturated alkyl groups were as shown in Table 1.

TABLE 1

| | Number of carbon atoms in saturated | | |
|---|---|---|---|
| Surfactants | alkyl groups represented by Ra | n | HLB |
| Surfactants 1 | 8 | 2 | 10.0 |
| Surfactants 2 | 8 | 3 | 11.2 |
| Surfactants 3 | 8 | 4 | 12.1 |
| Surfactants 4 | 8 | 6 | 13.5 |
| Surfactants 5 | 8 | 8 | 14.5 |
| Surfactants 6 | 8 | 10 | 15.2 |
| Surfactants 7 | 8 | 20 | 17.1 |
| Surfactants 8 | 10 | 5 | 11.4 |
| Surfactants 9 | 10 | 10 | 14.0 |
| Surfactants 10 | 10 | 20 | 16.3 |
| Surfactants 11 | 10 | 40 | 17.9 |
| Surfactants 12 | 10 | 100 | 19.1 |
| Surfactants 13 | 12 | 5 | 10.3 |
| Surfactants 14 | 12 | 10 | 13.0 |
| Surfactants 15 | 12 | 20 | 15.5 |
| Surfactants 16 | 12 | 40 | 17.4 |
| Surfactants 17 | 12 | 100 | 18.8 |
| Surfactants 18 | 13 | 5 | 9.8 |
| Surfactants 19 | 13 | 10 | 12.5 |
| Surfactants 20 | 13 | 20 | 15.1 |
| Surfactants 21 | 13 | 40 | 17.1 |
| Surfactants 22 | 13 | 100 | 18.7 |
| Surfactants 23 | 16 | 10 | 11.3 |
| Surfactants 24 | 16 | 20 | 14.1 |
| Surfactants 25 | 16 | 40 | 16.4 |
| Surfactants 26 | 16 | 100 | 18.4 |
| Surfactants 27 | 18 | 10 | 10.6 |
| Surfactants 28 | 18 | 20 | 13.5 |
| Surfactants 29 | 18 | 40 | 16.0 |
| Surfactants 30 | 18 | 100 | 18.2 |
| Surfactants 31 | 24 | 60 | 16.2 |

### Example 1

An ink composition containing the following components was prepared: 2.0% by weight of C. I. Acid Blue 290, 10.0% by weight of butyl triglycol, 10.0% by weight of glycerin, and 1.0% by weight of Olfine E1010, the remainder being ultrapure water.

### Example 2

An ink composition containing the following components was prepared: 2.0% by weight of C. I. Acid Blue 290, 10.0% by weight of butyl triglycol, 10.0% by weight of glycerin, 1.0% by weight of Olfine E1010, and 3.0% by weight of Surfactant 1, the remainder being ultrapure water.

### Examples 3 to 32

Ink compositions were prepared in Examples 3 to 32 using substantially the same components as those used in Example 2 except that Surfactants 2 to 31 shown in Table 1 were used instead of Surfactant 1.

### Examples 33 to 63

Ink compositions were prepared in Examples 33 to 63 using substantially the same components as those used in Examples 2 to 32 except that the content of each of the surfactants in the ink compositions was 15% by weight, although the content of each of Surfactants 2 to 31 in the ink compositions of Examples 2 to 32 was 3% by weight.

### Examples 64 to 124

Each ink composition was prepared so as to have the composition below in such a manner that components shown in Tables 2 to 9 were mixed together and the mixture was filtered through a 10-μm membrane filter. Values in Tables 2 to 9 represent the contents of the components on a weight percent basis. Surfactants used to prepare the ink compositions contained polyoxyethylene alkyl ethers which had Formula (I) and which contained saturated alkyl groups represented by Ra in Formula (I). The number of carbon atoms in the saturated alkyl groups, n in Formula (I), and the HLBs of the saturated alkyl groups were as shown in Table 1.

TABLE 2

| | Examples | | | | | | | |
|---|---|---|---|---|---|---|---|---|
| | 64 | 65 | 66 | 67 | 68 | 69 | 70 | 71 |
| C.I. Acid Blue | 2 | 2 | 2 | 2 | 2 | 2 | 2 | 2 |
| 290 | | | | | | | | |
| Butyl triglycol | 10 | 10 | 10 | 10 | 10 | 10 | 10 | 10 |
| Glycerin | 10 | 10 | 10 | 10 | 10 | 10 | 10 | 10 |
| Olfine E1010 | 1 | 1 | 1 | 1 | 1 | 1 | 1 | 1 |
| Ultrapure water | 72 | 72 | 72 | 72 | 71 | 71 | 71 | 71 |
| Surfactants 8 | 5 | | | | 6 | | | |
| Surfactants 17 | | 5 | | | | 6 | | |
| Surfactants 22 | | | 5 | | | | 6 | |
| Surfactants 26 | | | | | | | | |
| Surfactants 30 | | | | 5 | | | | 6 |
| Total | 100 | 100 | 100 | 100 | 100 | 100 | 100 | 100 |

TABLE 3

Examples

| | 72 | 73 | 74 | 75 |
|---|---|---|---|---|
| C.I. Acid Blue 290 | 2 | 2 | 2 | 2 |
| Butyl triglycol | 10 | 10 | 10 | 10 |
| Glycerin | 10 | 10 | 10 | 10 |
| Olfine E1010 | 1 | 1 | 1 | 1 |
| Ultrapure water | 75 | 75 | 75 | 75 |
| Surfactants 7 | 2 | | | |
| Surfactants 11 | | 2 | | |
| Surfactants 16 | | | 2 | |
| Surfactants 21 | | | | 2 |
| Total | 100 | 100 | 100 | 100 |

TABLE 4

| | Examples | | | | | | | | | |
|---|---|---|---|---|---|---|---|---|---|---|
| | 76 | 77 | 78 | 79 | 80 | 81 | 82 | 83 | 84 | 85 |
| C.I. Acid Blue 290 | 2 | 2 | 2 | 2 | 2 | 2 | 2 | 2 | 2 | 2 |
| Butyl triglycol | 10 | 10 | 10 | 10 | 10 | 10 | 10 | 10 | 10 | 10 |
| Glycerin | 10 | 10 | 10 | 10 | 10 | 10 | 10 | 10 | 10 | 10 |
| Olfine E1010 | 1 | 1 | 1 | 1 | 1 | 1 | 1 | 1 | 1 | 1 |
| Ultrapure water | 71 | 71 | 71 | 71 | 71 | 71 | 71 | 71 | 71 | 71 |
| Surfactants 3 | 3 | | | | | | 3 | 3 | 3 | 3 |
| Surfactants 10 | | 3 | | | | | | | | |
| Surfactants 14 | | | 3 | | | | 3 | | | |
| Surfactants 19 | | | | 3 | | | | 3 | | |
| Surfactants 24 | | | | | 3 | | | | 3 | |
| Surfactants 28 | | | | | | 3 | | | | 3 |
| Surfactants 31 | 3 | 3 | 3 | 3 | 3 | 3 | | | | |
| Total | 100 | 100 | 100 | 100 | 100 | 100 | 100 | 100 | 100 | 100 |
| | Examples | | | | | | | | | |
| | 86 | 87 | 88 | 89 | 90 | 91 | 92 | 93 | 94 | 95 |
| C.I. Acid Blue 290 | 2 | 2 | 2 | 2 | 2 | 2 | 2 | 2 | 2 | 2 |
| Butyl triglycol | 10 | 10 | 10 | 10 | 10 | 10 | 10 | 10 | 10 | 10 |
| Glycerin | 10 | 10 | 10 | 10 | 10 | 10 | 10 | 10 | 10 | 10 |
| Olfine E1010 | 1 | 1 | 1 | 1 | 1 | 1 | 1 | 1 | 1 | 1 |
| Ultrapure water | 71 | 71 | 71 | 71 | 71 | 71 | 71 | 71 | 71 | 71 |
| Surfactants 3 | | | | | 3 | | | | | |
| Surfactants 10 | 3 | 3 | 3 | 3 | 3 | | | | | |
| Surfactants 14 | 3 | | | | | 3 | | 3 | 3 | |
| Surfactants 19 | | 3 | | | | 3 | 3 | | | |
| Surfactants 24 | | | 3 | | | | 3 | 3 | | 3 |
| Surfactants 28 | | | | 3 | | | | | 3 | 3 |
| Surfactants 31 | | | | | | | | | | |
| Total | 100 | 100 | 100 | 100 | 100 | 100 | 100 | 100 | 100 | 100 |

TABLE 5

| | Examples | | | | | | |
|---|---|---|---|---|---|---|---|
| | 96 | 97 | 98 | 99 | 100 | 101 | 102 |
| C.I. Acid Blue 290 | 2 | 2 | 2 | 2 | 2 | 2 | 2 |
| Butyl triglycol | 10 | 10 | 10 | 10 | 10 | 10 | 10 |
| Glycerin | 10 | 10 | 10 | 10 | 10 | 10 | 10 |
| Olfine E1010 | 1 | 1 | 1 | 1 | 1 | 1 | 1 |
| Ultrapure water | 71 | 71 | 71 | 71 | 71 | 73 | 75 |
| Surfactants 3 | 5 | 4 | 3 | 2 | 1 | 2 | 1 |
| Surfactants 31 | 1 | 2 | 3 | 4 | 5 | 2 | 1 |
| Total | 100 | 100 | 100 | 100 | 100 | 100 | 100 |

TABLE 6

| | Examples | | | | | |
|---|---|---|---|---|---|---|
| | 103 | 104 | 105 | 106 | 107 | 108 |
| C.I. Acid Blue 239 | 2 | 2 | 2 | 2 | 2 | 2 |
| Butyl triglycol | 10 | 10 | 10 | 10 | 10 | 10 |
| Glycerin | 10 | 10 | 10 | 10 | 10 | 10 |
| Olfine E1010 | 1 | 1 | 1 | 1 | 1 | 1 |
| Ultrapure water | 77 | 71 | 71 | 71 | 71 | 71 |
| Surfactants 3 | | 3 | | | | |
| Surfactants 10 | | | 3 | | | |
| Surfactants 14 | | | | 3 | | |
| Surfactants 19 | | | | | 3 | |
| Surfactants 24 | | | | | | 3 |
| Surfactants 31 | | 3 | 3 | 3 | 3 | 3 |
| Total | 100 | 100 | 100 | 100 | 100 | 100 |

TABLE 7

| | Examples | | | | | |
|---|---|---|---|---|---|---|
| | 109 | 110 | 111 | 112 | 113 | 114 |
| C.I. Acid Blue 258 | 2 | 2 | 2 | 2 | 2 | 2 |
| Butyl triglycol | 10 | 10 | 10 | 10 | 10 | 10 |
| Glycerin | 10 | 10 | 10 | 10 | 10 | 10 |
| Olfine E1010 | 1 | 1 | 1 | 1 | 1 | 1 |
| Ultrapure water | 77 | 71 | 71 | 71 | 71 | 71 |
| Surfactants 3 | | 3 | | | | |
| Surfactants 10 | | | 3 | | | |
| Surfactants 14 | | | | 3 | | |
| Surfactants 19 | | | | | 3 | |
| Surfactants 24 | | | | | | 3 |
| Surfactants 31 | | 3 | 3 | 3 | 3 | 3 |
| Total | 100 | 100 | 100 | 100 | 100 | 100 |

TABLE 8

| | Examples | | | | | |
|---|---|---|---|---|---|---|
| | 115 | 116 | 117 | 118 | 119 | 120 |
| C.I. Acid Blue 280 | 2 | 2 | 2 | 2 | 2 | 2 |
| Butyl triglycol | 10 | 10 | 10 | 10 | 10 | 10 |
| Glycerin | 10 | 10 | 10 | 10 | 10 | 10 |
| Olfine E1010 | 1 | 1 | 1 | 1 | 1 | 1 |
| Ultrapure water | 77 | 71 | 71 | 71 | 71 | 71 |
| Surfactants 3 | | 3 | | | | |
| Surfactants 10 | | | 3 | | | |
| Surfactants 14 | | | | 3 | | |
| Surfactants 19 | | | | | 3 | |
| Surfactants 24 | | | | | | 3 |
| Surfactants 31 | | 3 | 3 | 3 | 3 | 3 |
| Total | 100 | 100 | 100 | 100 | 100 | 100 |

TABLE 9

Examples

| | 121 | 122 | 123 | 124 |
|---|---|---|---|---|
| C.I. Acid Blue 239 | 2 | | | |
| C.I. Acid Blue 258 | | 2 | | |
| C.I. Acid Blue 280 | | | 2 | |
| C.I. Acid Blue 290 | | | | 2 |
| Butyl triglycol | 10 | 10 | 10 | 10 |
| Glycerin | 10 | 10 | 10 | 10 |
| Olfine E1010 | 1 | 1 | 1 | 1 |
| Ultrapure water | 71 | 71 | 71 | 71 |
| Surfactants 14 | 3 | 3 | 3 | 3 |
| Surfactants 31 | 3 | 3 | 3 | 3 |
| Total | 100 | 100 | 100 | 100 |

### Evaluation of Ink Compositions

Portions of the ink compositions, which were prepared as described above, were filtered through membrane filters, Omnipore™, having a pore size of 1 μm, available from Millipore Corporation and then stored in containers, which were hermetically sealed such that the ink compositions were prevented from being dried. The ink compositions stored in the containers were left at 70° C., 60° C., 50° C., and 40° C. for one week and 100 ml of each ink composition was filtered through a membrane filter having a pore size of 1 μm again. Deposits (hereinafter referred to as the first deposits) remaining on the membrane filter, through which the ink composition was filtered, were collected and then weighed. Other portions of the ink compositions were left at 70° C., 60° C., 50° C., 40° C., and 25° C. and deposits (hereinafter referred to as the second deposits) obtained therefrom were collected and then weighed. The ink compositions were evaluated as follows: a rating of 7 was given to an ink composition in which the sum of the weight of the first deposits and the weight of the second deposits was 1.4 g or more, a rating of 6 was given to an ink composition in which the sum thereof was 1.2 to less than 1.4 g, a rating of 5 was given to an ink composition in which the sum thereof was 1.0 to less than 1.2 g, a rating of 4 was given to an ink composition in which the sum thereof was 0.8 to less than 1.0 g, a rating of 3 was given to an ink composition in which the sum thereof was 0.6 to less than 0.8 g, a rating of 2 was given to an ink composition in which the sum thereof was 0.4 to less than 0.6 g, a rating of 1 was given to an ink composition in which the sum thereof was 0.2 to less than 0.4 g, and a rating of 0 was given to an ink composition in which the sum thereof was less than 0.2 g. The evaluation results are summarized in Table 10 below.

TABLE 10

| | Examples | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| Rating | 7 | 6 | 6 | 2 | 2 | 3 | 3 | 4 | 5 | 3 | 3 | 4 | 6 | 6 | 2 | 3 |
| | Examples | | | | | | | | | | | | | | | |
| | 17 | 18 | 19 | 20 | 21 | 22 | 23 | 24 | 5 | 26 | 27 | 28 | 29 | 30 | 31 | 32 |
| Rating | 4 | 5 | 6 | 2 | 3 | 4 | 5 | 6 | 3 | 3 | 5 | 6 | 2 | 3 | 5 | 3 |
| | Examples | | | | | | | | | | | | | | | |
| | 33 | 34 | 35 | 36 | 37 | 38 | 39 | 40 | 41 | 42 | 43 | 44 | 45 | 46 | 47 | 48 |
| Rating | 5 | 5 | 2 | 2 | 2 | 2 | 3 | 4 | 2 | 2 | 3 | 5 | 5 | 2 | 2 | 3 |

| | Examples | | | | | | | | | | | | | | |
|---|---|---|---|---|---|---|---|---|---|---|---|---|---|---|---|
| | 49 | 50 | 51 | 52 | 53 | 54 | 55 | 56 | 57 | 58 | 59 | 60 | 61 | 62 | 63 |
| Rating | 4 | 5 | 2 | 2 | 3 | 4 | 5 | 2 | 2 | 4 | 5 | 2 | 2 | 4 | 2 |

| | Examples | | | | | | | | | | | | | | | |
|---|---|---|---|---|---|---|---|---|---|---|---|---|---|---|---|---|
| | 64 | 65 | 66 | 67 | 68 | 69 | 70 | 71 | 72 | 73 | 74 | 75 | 76 | 77 | 78 | 79 |
| Rating | 5 | 5 | 5 | 5 | 4 | 4 | 4 | 4 | 5 | 5 | 5 | 5 | 0 | 0 | 2 | 2 |
| | Examples | | | | | | | | | | | | | | | |
| | 80 | 81 | 82 | 83 | 84 | 85 | 86 | 87 | 88 | 89 | 90 | 91 | 92 | 93 | 94 | 95 |
| Rating | 2 | 2 | 0 | 0 | 0 | 0 | 0 | 0 | 0 | 0 | 2 | 2 | 2 | 2 | 2 | 2 |

| | Examples | | | | | | | | | | | | | | | |
|---|---|---|---|---|---|---|---|---|---|---|---|---|---|---|---|---|
| | 96 | 97 | 98 | 99 | 100 | 101 | 102 | 103 | 104 | 105 | 106 | 107 | 108 | 109 | 110 | 111 |
| Rating | 2 | 0 | 0 | 0 | 2 | 0 | 2 | 7 | 0 | 0 | 2 | 2 | 2 | 7 | 0 | 0 |

| | Examples | | | | | | | | |
|---|---|---|---|---|---|---|---|---|---|
| | 112 | 113 | 114 | 115 | 116 | 117 | 118 | 119 | 120 |
| Rating | 2 | 2 | 2 | 7 | 0 | 0 | 2 | 2 | 2 |

The following agent was applied to sheets of nylon taffeta: a pretreatment agent containing 1.0% by weight of sodium alginate, 1.0% by weight of guar gum, 4.0% by weight of ammonium sulfate, and 10.0% by weight of urea, the remainder being ultrapure water. The nylon taffeta sheets were mangled at a pickup of 30% and then dried. The resulting nylon taffeta sheets were printed with the ink compositions prepared in Examples 121 to 124 using a printer, PM-A750, available from Seiko Epson Corporation and then subjected to fixing at 110° C. for 30 minutes by steaming. The resulting nylon taffeta sheets were washed with Olfine E1010 available from Nissin Chemical Industry Co., Ltd. and a 0.2% aqueous solution of Laccorl STA available from Meisei Chemical Works, Ltd. at 55° C. for ten minutes and then dried, whereby specimens were prepared. The specimens were evaluated for light resistance by a test method for colour fastness to xenon arc lamp light according to JIS L 0843 A, whereby the specimens were graded. The evaluation results are summarized in Table 11 below.

TABLE 11

Examples

| | 121 | 122 | 123 | 124 |
|---|---|---|---|---|
| Light resistance (grade) | 4 | 6-5 | 6-5 | 6 |

1. An ink composition for ink-jet printing, containing:
a water-soluble dye having an anthraquinone skeleton and a water solubility of 50 g/L or less at 30° C.; and
at least one polyoxyethylene alkyl ether having an HLB of 11.4 to 18.8 and the following formula: 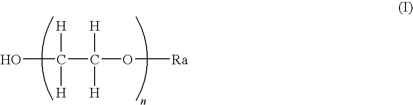
wherein n is four to 100 and Ra is a saturated alkyl group with eight to 24 carbon atoms.

2. The ink composition according to claim 1, wherein the water-soluble dye is C. I. Acid Blue 258, 280, or 290.

3. The ink composition according to claim 1, wherein the polyoxyethylene alkyl ether has an HLB of 12.1 to 17.9.

4. The ink composition according to claim 1, wherein the polyoxyethylene alkyl ether has an HLB of 12.1 to 16.4 and n in Formula (I) is four to 60.

5. The ink composition according to claim 1, wherein the content of the polyoxyethylene alkyl ether in the ink composition is 6% to 15% by weight.

6. The ink composition according to claim 3, wherein the content of the polyoxyethylene alkyl ether in the ink composition is 3% to 15% by weight

7. The ink composition according to claim 1, wherein the ratio of the content of the water-soluble dye to the content of the polyoxyethylene alkyl ether in the ink composition is 1.0:3.0 to 1.0:7.5.

8. The ink composition according to claim 3, wherein the ratio of the content of the water-soluble dye to the content of the polyoxyethylene alkyl ether in the ink composition is 1.0:1.5 to 1.0:7.5.

9. The ink composition according to claim 1, wherein the polyoxyethylene alkyl ether includes a first polyoxyethylene alkyl ether which has Formula (I), which contains a saturated alkyl group, represented by Ra, having eight to ten carbon atoms, and in which n in Formula (I) is four to 20 and a second polyoxyethylene alkyl ether which has Formula (I), which contains a saturated alkyl group, represented by Ra, having 12 to 24 carbon atoms, and in which n in Formula (I) is 10 to 60.

10. The ink composition according to claim 9, wherein the sum of the content of the first polyoxyethylene alkyl ether and the content of the second polyoxyethylene alkyl ether in the ink composition is 4% by weight or more.

11. The ink composition according to claim 9, wherein the ratio of the content of the first polyoxyethylene alkyl ether and the content of the second polyoxyethylene alkyl ether in the ink composition is 1:5 to 5:1.

12. The ink composition according to claim 9, wherein the sum of the content of the first polyoxyethylene alkyl ether and the content of the second polyoxyethylene alkyl ether in the ink composition is 2.0 times or more the content of the water-soluble dye in the polyoxyethylene alkyl ether.

13. An ink-jet printing method comprising using the ink composition according to claim 1.
